(19) United States
(12) Patent Application Publication
(10) Pub. No.: US 2010/0156886 A1
(43) Pub. Date: Jun. 24, 2010

(54) REDUCING PSEUDO CONTOURS IN DISPLAY DEVICE

(76) Inventor: Kazuyoshi Kawabe, Yokohama (JP)

Correspondence Address: MCKENNA LONG & ALDRIDGE LLP, 1900 K STREET, NW, WASHINGTON, DC, 20006, US

(21) Appl. No.: 12/615,300

(22) Filed: Nov. 10, 2009

(30) Foreign Application Priority Data
Dec. 19, 2008 (JP) 2008-323913

(51) Int. Cl. G09G 3/30; G06F 3/038

(52) U.S. Cl. 345/214; 345/78

(57) ABSTRACT

A display device for performing display by digitally driving pixels, arranged in a matrix arrangement, according to image data of an image signal. A data driver allocates pixel data for a single pixel to corresponding sub-frames as a plurality of bit data, and digitally drives each pixel by providing bit data to each pixel, the bit data having one frame formed from a specified number of unit frames. A timing control circuit divides the image signal into blocks for analysis, analyzes likelihood of occurrence of pseudo contours for each block, and analyzes likelihood of occurrence of pseudo contours for display of a single screen based on analysis results in each block. The timing control circuit then changes display based on the image signal based on analysis results by the timing control circuit.

### CROSS-REFERENCE TO RELATED APPLICATIONS

This application claims priority of Japanese Patent Application No. 2008-323913 filed Dec. 19, 2008 which is incorporated herein by reference in its entirety. Reference is made to commonly-assigned U.S. patent application Ser. No. ______ filed concurrently herewith, entitled “Display Device” by Kazuyoshi Kawabe, the disclosure of which is incorporated herein.

### FIELD OF THE INVENTION

The present invention relates to a display device for performing display by digitally driving pixels, arranged in a matrix arrangement, according to image data of an image signal.

### BACKGROUND OF THE INVENTION

Development of organic EL displays has been aggressively pursued in recent years. If organic EL, which is a self-emissive element, is used in a display, there is the advantage of high contrast, and fast response, and so there is the expectation of being able to perform display without causing blurring in movies with a lot of movement.

Currently, due to demands for high definition and high resolution, active matrix type displays that have organic EL elements driven by thin film transistors (TFTs) have become mainstream, manufactured by forming organic EL elements on a base on which low temperature polysilicon TFTs are formed. Low temperature polysilicon TFTs have high mobility and stable operation, making them suitable as drive elements for organic EL, but variations in characteristics such as threshold value and mobility are large, and if fixed current drive is performed in the saturation region there is variation in brightness between pixels, and there is a problem in that unevenness in brightness appears in the display. Therefore, digital driving in which the TFTs are driven in a linear region, and used as switches to reduce display unevenness, has been disclosed.

With the digital driving disclosed in U.S. Patent Application Publication No. 2005/0212740 A1 and U.S. Patent Application Publication No. 2008/0088561 A1, a pixel is controlled to two values according to whether or not it emits light, and gradation display is performed using a plurality of sub-frames. This driving method is called sub-frame type digital driving.

However, with the related art sub-frame type digital driving, it is easy for pseudo contours to arise, and particularly in still pictures, suppression of pseudo contours due to high speed line of sight movement is difficult. A method for raising frequency (refresh rate) and suppressing pseudo contours is disclosed in U.S. Patent Application Publication No. 2005/0212740 A1, but if frequency is increased there is a problem of increased power consumption, and high frequency drive at the time of normal operation is not desirable.

If it is possible to vary the refresh rate according to an image, it is possible to only raise the frequency in the case of displaying an image that has a high possibility of pseudo contours arising, to suppress increase in power consumption as much as possible.

When the refresh rate is varied, it becomes necessary to determine an image in which pseudo contours occur with good accuracy. If degree of pseudo contours is detected with good accuracy, it is possible to determine what frequency should be set, and it is therefore possible to effectively suppress pseudo contours and at the same time reduce power consumption. If detection accuracy is bad, frequency can be erroneously raised or lowered beyond that which is required, and effectively achieving both pseudo contour suppression effects and reduced power consumption effects cannot be expected.

### SUMMARY OF THE INVENTION

The present invention provides a display device for performing display by digitally driving pixels, arranged in a matrix arrangement, according to image data of an image signal, including a driver that divides pixel data for a single pixel into corresponding sub-frames as a plurality of bit data, and forms one frame from a specified repeating number of unit frames, and digitally drives each pixel by providing the bit data to each pixel, and an analyzing circuit for dividing the image signal into blocks for analysis, analyzing likelihood of occurrence of pseudo contours for each block, and analyzing likelihood of occurrence of pseudo contours for display of a single screen based on analysis results of each block, wherein a method of display based on the image signal is changed based on analysis results by the analysis section.

It is also preferable for the analyzing circuit to have a plurality of methods for dividing the blocks, and together with respectively analyzing likelihood of occurrence of pseudo contours for blocks that have been divided with the plurality of methods, likelihood of occurrence of pseudo contours in display of one screen is analyzed based on results of analysis for each block that has been divided with the plurality of methods.

It is also preferable for the plurality of methods to include dividing into square regions made up of a plurality of pixels of the same height and width, and a dividing into rectangular regions having different height and width.

It is also preferable for the rectangular regions of the plurality of methods to include horizontally long rectangular regions and vertically long rectangular regions.

It is also preferable, in analysis results for blocks divided using the plurality of methods, for the analyzing circuit to assess a weight for each method, to analyze display of one screen.

It is also preferable for the analyzing circuit to make analysis results for which it has been determined that occurrence of pseudo contours is most likely, among the analysis results of each block, the analysis results for display of one screen.

It is also preferable for the driver to change a number of unit frames of a single frame based on analysis results of the analyzing circuit.

It is also preferable for the analyzing circuit to compare pixel data for subject pixels and pixel data around the subject pixels, to determine whether or not there is likelihood of occurrence of pseudo contours.

It is also preferable for the analyzing circuit to compare pixel data for subject pixels and pixel data around the subject pixels, for every bit, to determine whether or not there is likelihood of occurrence of pseudo contours.

It is also possible for the analyzing circuit to change a number of block divisions according to frequency of image variation, to analyze likelihood of occurrence of pseudo contours.

It is also preferable that in the event that the frequency of image variation is low, the analyzing section increases a number of divisions of the blocks, and when the frequency of image variation is high decreases the number of divisions of the blocks.

It is also preferable for the pixels to include an organic EL element.

According to the present invention, by dividing into blocks and detecting likelihood of occurrence of pseudo contours within the blocks, appropriate detection of pseudo contours can be carried out. In particular, by providing a plurality of ways of carrying out block division, it becomes possible to more appropriately detect pseudo contours.

### BRIEF DESCRIPTION OF THE DRAWINGS

FIG. 1 is a drawing showing the overall structure of a display device of this embodiment;

FIG. 2 is a drawing showing the internal structure of a timing control circuit;

FIG. 3 is a drawing showing a pattern with which pseudo contours are likely to occur;

FIG. 4 is a drawing showing light emitting elements of adjacent pixels when driven at four times speed;

FIG. 5A is a drawing showing an example of pseudo contour occurrence of the distributed type;

FIG. 5B is a drawing showing an example of the occurrence of concentrated type pseudo contours;

FIG. 5C is a drawing showing an example of the occurrence of linear type pseudo contours;

FIG. 6A is a drawing showing an example of a block formation using square division;

FIG. 6B is a drawing showing an example of a block formation using horizontally long division;

FIG. 6C is a drawing showing an example of a block formation using vertically long division;

FIG. 7A is a drawing showing an example of a histogram for distributed type critical transitions;

FIG. 7B is a drawing showing an example of a histogram for concentrated type critical transitions;

FIG. 7C is a drawing showing an example of a histogram for linear type critical transitions;

FIG. 8 is a drawing showing the schematic structure of a data analysis circuit;

FIG. 9A is a drawing showing an example of threshold type refresh rate setting;

FIG. 9B is a drawing showing an example of step type refresh rate setting;

FIG. 9C is a drawing showing an example of continuous type refresh rate setting;

FIG. 10 is a drawing showing the structure of a pixel;

FIG. 11 is a timing chart for digital drive at four times speed;

FIG. 12A is a timing chart showing one example of a method of changing a unit frame period;

FIG. 12B is a timing chart showing another example of a method of changing a unit frame period;

FIG. 12C is a timing chart showing yet another example of a method of changing a unit frame period;

FIG. 13 is a drawing showing the structure of a pixel having three sub-pixels arranged with a common select line to form a single pixel;

FIG. 14 is a timing chart for the case of carrying out-bit gradation display using the pixel of FIG. 13;

FIG. 15 is a drawing showing the overall structure of a display device containing the pixels of FIG. 13; and

FIG. 16 is a drawing showing the schematic structure of another example of a data analysis circuit of FIG. 8.

### DETAILED DESCRIPTION OF THE INVENTION

Embodiments of the present invention will be described in the following based on the drawings.

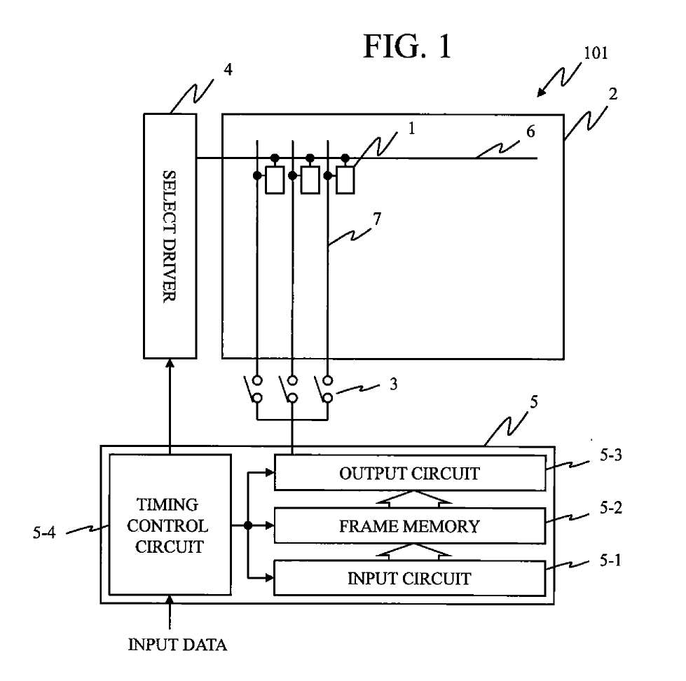

The overall structure of a display device 101 of this embodiment is shown in FIG. 1. The display device 101 includes a pixel array 2 having pixels 1 for generating the colors R (red) G (green) and B (blue) arranged in a matrix, a select driver 4 for selectively driving select lines 6, a data driver 5 for driving data lines 7, and a multiplexor 3 for connecting outputs of the data driver 5 to data lines 7 for each of RGB.

Here, a pixel 1 is constructed with three pixels for each of RGB to constitute a full color unit pixel that can give fill color, but it is also possible to further include a pixel 1 for emitting W (white) to make a full color unit pixel as RGBW. In this case, a data line 7 for W is further provided in the multiplexor 3. With this example, a stripe type has been adopted where a pixel 1 for one of the colors RGBW is arranged in each row, but it is also possible to use a delta type.

The data driver 5 shown in FIG. 1 is made up of an input circuit 5-1, a frame memory 5-2, an output circuit 5-3, and a timing control circuit 5-4, and operates as a built-in memory type data driver. Dot unit data input from outside is input to the timing control circuit 5-4, control signals are generated according to the input data, and these control signals are supplied to the input circuit 5-1, frame memory 5-2 and output circuit 5-3.

Dot unit data output from the timing control circuit 5-4 is converted to data in line units by the input circuit 5-1, and stored in line units in the frame memory 5-2. Data stored in the frame memory 5-2 is read out in line units and transferred to the output circuit 5-3. The multiplexor 3 sequentially selects, for example, from R to G to B, and if the respective datelines 7 for RGB are sequentially connected to the output circuit 5-3 corresponding data is output to the respective data lines 7 in the order R to G to B in line units.

If the multiplexor 3 is used in this way, the number of outputs of the data driver 5 can be made only the number of full color unit pixels, which simplifies the structure, and is therefore good for use in a mobile terminal. For example, in the case of a QVGA of 240×320, the number of outputs of the data driver 5 amounts to 240 and it is possible to make the circuit scale of the output circuit 5-3 as small as possible, which is helpful in reducing costs. If the multiplexor 3 were to be omitted, it would be necessary to connect outputs of the data driver 5 to all of the RGB data lines 7, and 240×3=720 outputs would be required. The select driver 4 selects a select line 6 for a line on which data is selected, at the time when data is output to the data line 7. In this way, data from the data driver 5 is appropriately written to the pixel 1 of the line in question. Once data is written in, the select driver 4 releases selection of the relevant line, selects the next line to be selected, and repeats the release operation. Specifically, the select driver 4 must operate so as to select only one line at a time.

The select driver 4 is more often than not manufactured with low temperature polysilicon TFTs, on the same substrate as the pixels, but it is also possible to provide the select driver 4 as a driver IC, or to incorporate the select driver 4 into the data driver 5.

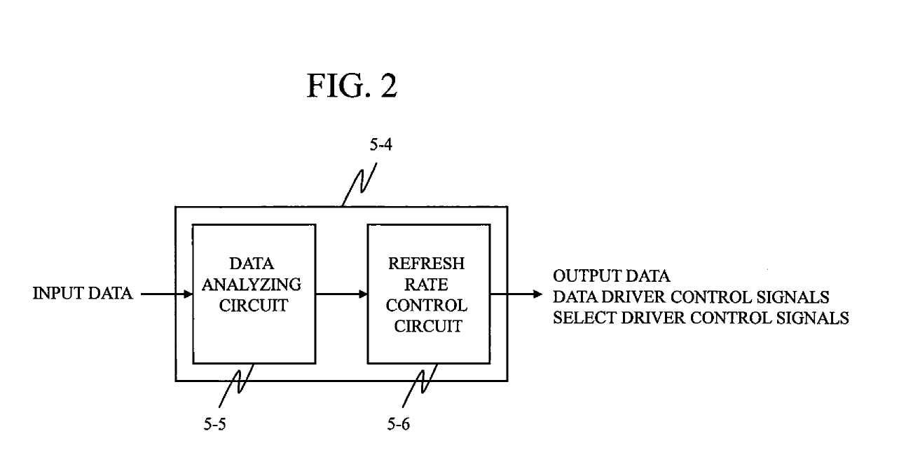

The internal structure of a timing control circuit 5-4 is shown in FIG. 2. Dot unit input data is input to the data analyzing circuit 5-5 inside the timing control circuit 5-4, and what type of data is contained in the image/video is analyzed. Based on the result of this analysis, various control signals for generating the optimum refresh rate are output by the refresh rate control circuit 5-6 inside the timing control circuit 5-4. Control signals generated by the refresh rate control circuit 5-6 are supplied to the frame memory 5-2, the output circuit 5-3 and the select driver 4, and the display device 101 displays images at a refresh rate that is appropriate for the image data.

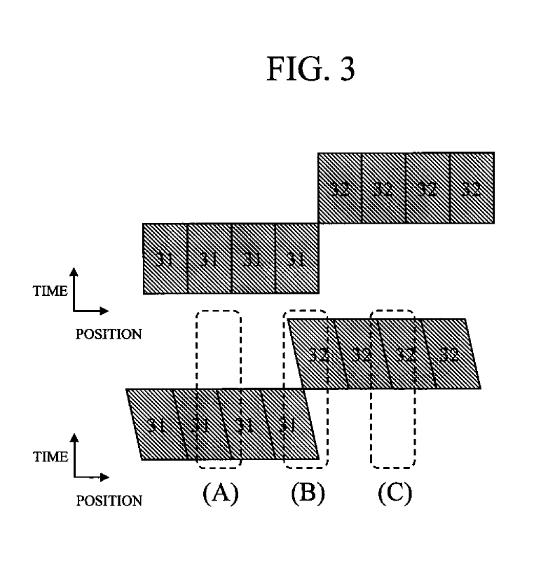

An example of a pattern that is prone to the occurrence of pseudo contours is shown in FIG. 3. The display example of FIG. 3 contains a critical transition displaying gradation data “31” and gradation data “32” adjacently, at the time of 6-bit gradation display where each subframe SF0-SF5 is respectively weighted at 1:2:4:8:16:32. In the case where there is no line of sight movement, there is no interference between gradations, as shown at the upper part of FIG. 3, and so pseudo contours do not occur, but with a normal refresh rate of 60 Hz, due to line of sight movement emitted light in adjacent pixels interferes with each other, as shown in the lower part of FIG. 3, and it looks as if gradations that are different from those of a natural display are being displayed. Specifically, gradation data “31” is displayed in the region (A), and gradation data “32” is displayed in the region (C), with the appearance being coincident with the upper part of FIG. 3, but in a region (B) where the two interfere with each other gradations that are brighter than they should be appear, and therefore this constitutes a pseudo contour and causes unnatural display.

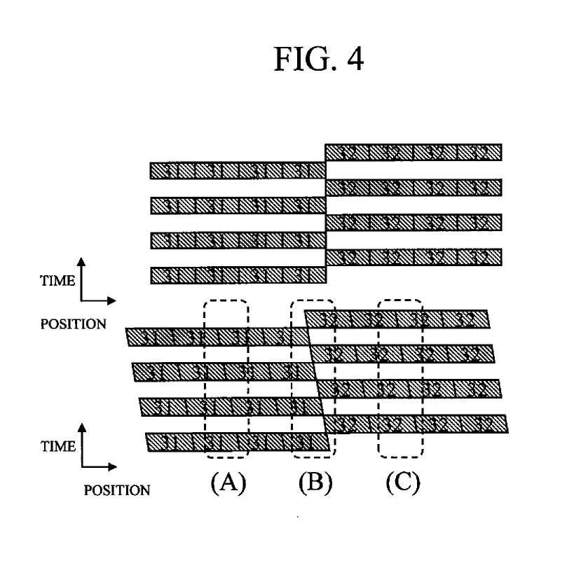

FIG. 4 shows light emitting elements of adjacent pixels when driven at 240 Hz (four times speed), for example, in order to improve this pseudo contour. In the region (B), if the speed becomes a high speed of fours times speed, the time when the two gradations interfere due to line of sight movement becomes short, and so it is possible to suppress pseudo contours. According to tests by the inventor, if display was performed at three to four times speed, it was possible to sufficiently suppress pseudo contours, and so it is understood that if driving is possible at a maximum of four times speed, it is possible to achieve favorable display.

However, in the case of four times speed, the refresh rate becomes four times the normal refresh rate, and there is an increase in the power consumption of the data driver 5. In particular, there is further increase in power consumption when the number of subframes becomes large accompanying multiple gradations, and it is therefore not preferable to always proactively make the speed four times speed.

With this embodiment, the extent to which critical transitions are contained in an image is accurately analyzed by the data analyzing circuit 5-5, and when displaying an image for which it is likely that pseudo contours will arise, or in which the pseudo contours will be noticeable, the refresh rate control circuit 5-6 proactively increases the refresh rate to improve image quality, while when displaying an image for which pseudo contours are unlikely to occur, or will not be noticeable, the refresh rate is proactively lowered, making it possible to reduce power consumption.

The detecting of critical transitions can be performed as follows. It is possible to have a method where respective bit data for each pixel, and for peripheral pixel groups contained included to the left and right, above and below, or diagonally next to each pixel, are subjected to respective OR operations, and cases where results of comparison of the original data with the ORed data are significantly different are determined to be critical transitions. For example, consider a case where there is a pixel of gradation data “32 (100000)” in the vicinity of a pixel of gradation data “31 (011111)”. A result of a bit OR operation between the two becomes “63 (111111)”, and thus becomes a difference of about twice that of the original “31”. This constitutes a critical transition with a pseudo contour shown in FIG. 3 appearing very noticeably, and so it will be understood that at the normal refresh rate it is unacceptable. On the other hand, in the case of gradation data of adjacent pixels of “31 (011111)” and “30 (011110)”, the result of the bit OR operation is “31 (011111)” and there is almost no difference from the original data, and so it will be understood that there is no critical transition, and the normal refresh rate is sufficient.

Even in a case where the gradation data for adjacent pixels is not consecutive, such as “33 (100001)” and “30 (011110)”, since the bit OR operation result becomes “63 (111111)” it constitutes a critical transition, and it is possible to detect critical transitions easily by comparing the bit operation result and data. It is also possible to similarly detect critical transitions using bit operations other than the bit OR operation, such as a bit AND operation. For example, in the previous case of gradation data “31 (011111)” and “32(100000)”, if they are respectively subjected to a bit AND operations they become “0(000000)”, giving a result is significantly different from the original data of “31(011111)”, but on the other hand, in the case of gradation data “31(011111)” and “30(011110)” the bit AND operation result becomes “30(011110), which has almost no difference from the original gradation data, so it is possible to determine that there is no critical transition.

Detection of critical transitions can be carried out independently for each of RGB, but it will be understood that there are cases that do not correspond to a critical transition, depending on the display state of each color. Specifically, even if there is a critical transition for any one color, if any of the remaining colors are changing rapidly the pseudo contour for that color becomes less noticeable. For example, in the case where R is a critical transition and G or B are changing rapidly, it goes without saying that there will be cases where there is an edge in either G or B, and the effect of this edge is to negate the pseudo contour of R, reducing the effect. In order to achieve more accurate pseudo contour detection, it is desirable to determine whether or not there is a critical transition taking into consideration gradation changes for different colors.

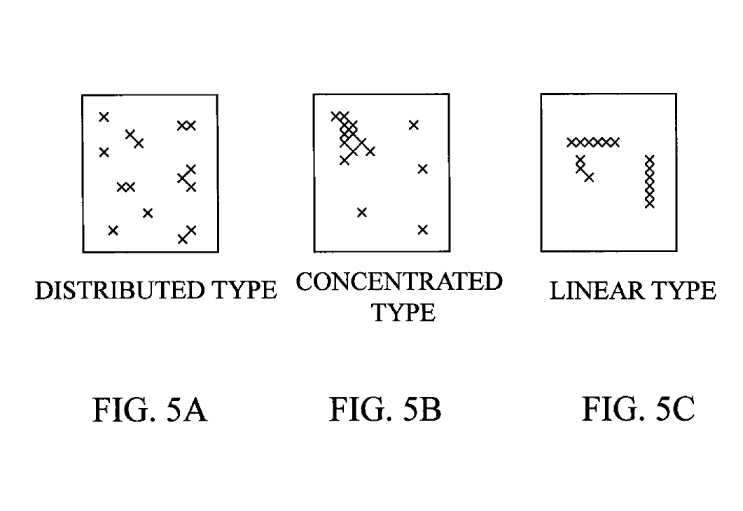

In this way critical transitions (CT) are detected with good accuracy, and if the extent to which critical transitions exist in an image is counted it is possible to quantify the likelihood of occurrence of pseudo contours. However, as a result of experiments by the present inventors, it became clear simply by counting critical transitions that a difference arises between the number of critical transitions and their appearance. As a result of analyzing the reason for this, it was found that critical transitions have a tendency to be distributed differently depending on the image, and it is generally possible to classify into three types, as shown in FIG. 5A to FIG. 5C.

FIG. 5A to FIG. 5C show three typical examples where the same number of critical transitions are included (shown by x in the drawing), but a different distribution is adopted. FIG. 5A shows an example in the case of critical transitions being uniformly dispersed over the whole screen (distributed type), FIG. 5B shows the case where they are concentrated in a particular region (concentrated type), and FIG. 5C shows the case where they are aligned linearly (linear type). The case where the critical transitions are dispersed in a scattered manner, as in FIG. 5A, often appears in images with a lot of text, for example. With this case pseudo contours are barely noticeable, and it is possible to lower the refresh rate to reduce power consumption. Cases such as the concentrated type shown in FIG. 5B often appear in images such as photographs, and pseudo contours are likely to occur. In particular, since human skin often has gradation that varies smoothly, there is a tendency for pseudo contours to concentrate. This is also true for cases including both text and photographs, such as web pages. Specifically, there is a tendency for a lot of critical transitions to appear in regions where photographs are arranged.

If critical transitions are concentrated in a particular region, as shown in FIG. 5B, due to a sense of discomfort with the display the viewer's line of sight will be drawn to that region, and there is a tendency for the pseudo contours to have a pronounced impression. It is therefore preferable to lower the refresh rate in this type of situation. In situations where there is not the concentration of FIG. 5B, as in the linear type of FIG. 5C, pseudo contours occur in a line and are easily noticeable, and so lowering of the refresh rate should be avoided. From this type of analysis result, it becomes clear that even if the number of occurrences of critical transitions is the same, the sensitivity of the pseudo contours and the likelihood of them being noticeable is different depending on distribution, and more detailed data analysis is required.

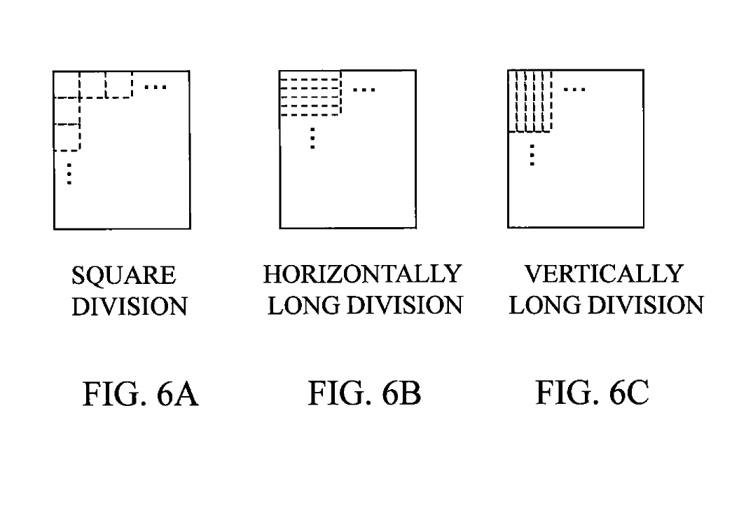

Therefore, a screen is divided into a plurality of areas, as in FIG. 6A to FIG. 6C, critical transitions are counted for each area, and more detailed data analysis is carried out.

Three types of division method are shown in FIG. 6. FIG. 6A shows an example of square division where a screen is divided into square areas having substantially the same height and width, FIG. 6B shows an example of horizontally long division where the screen is divided into strip areas that are long in the horizontal direction, and FIG. 6C shows an example of vertically long division where the screen is divided into strips that are long in the vertical direction.

With images of the distributed type of FIG. 5A and the concentrated type of FIG. 5B, critical transition distribution can be evaluated using the square division of FIG. 6A. On the other hand, with images of the linear type of FIG. 5C, there is a limitation on the detection accuracy with the square division of FIG. 6A. Therefore, by dividing into the horizontal and vertical strips of FIG. 6B and FIG. 6C, critical transition distribution that has a linear arrangement is evaluated.

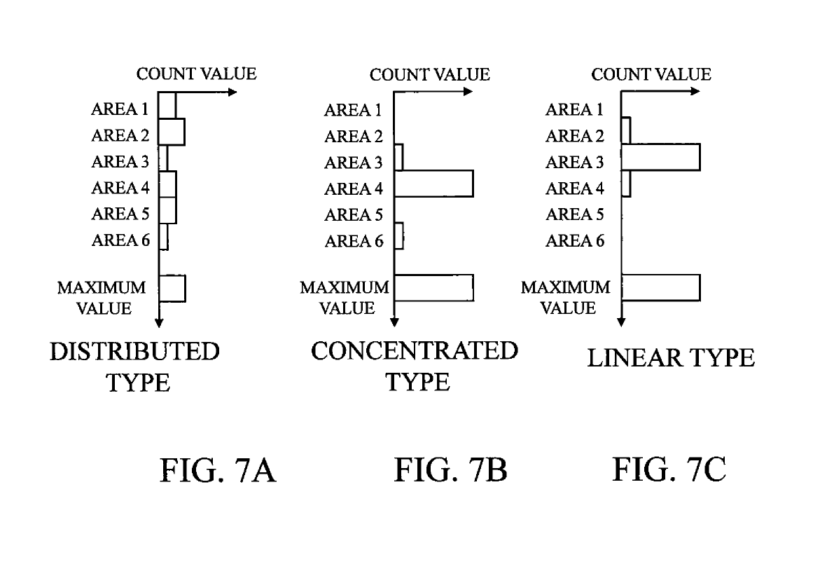

If 400 pixels of, for example, 20×20 are made into a single region with the square division of FIG. 6A, then in the case of a screen resolution of QVGA (240 RGB×320), it is possible to divide equally into a total of 192 regions, 12 wide and 16 high. If respective critical transitions in each of the 192 regions are counted, it is possible to crate a histogram for each area, as shown in FIG. 7A and FIG. 7B. In the case of the distributed type of FIG. 5A, there is a substantially equal low count distribution in each area, but with the concentrated type of FIG. 5B distribution exhibits a peak in a particular region. By utilizing this difference in characteristic, it is possible to determine whether the critical transitions are distributed or concentrated.

Specifically, if a maximum value of a critical transition count for every area is checked, it can be known to a certain extent whether the critical transitions are distributed or concentrated.

In the case of the linear distribution of FIG. 5C, linear distribution is detected accurately using the horizontally long division of FIG. 6B and the vertically long division of FIG. 6C, but if a unit horizontally long region is made, for example 80×5, it has 400 pixels, and it is possible to divide into the same 192 regions with a unit region number of pixels that is the same as for the previously described square division. If a case is assumed where a critical transition is 80 dots or more, and arranged linearly in the horizontal direction, in a horizontally long region it is possible to detect a critical transition of 80 pixels, but in a square region it is only possible to detect a critical transition of 20 pixels. Since the overall number of pixels inside the region is the same, namely 400, the detection accuracy is four times higher for the horizontally long region. Similarly for the vertically long region, detection accuracy for critical transition arranged linearly in the vertical direction is four times that of a square region, enabling detection with high accuracy. Using the horizontally long or vertically long division of FIG. 6B or FIG. 6C, a histogram that has been processed in the case of the linear distribution of FIG. 5C becomes as shown in FIG. 7C, and in this case also distribution exhibits a peak in a particular region.

In this way, critical transitions are counted from each area acquired by subjecting the entire screen to square division, horizontally long division and vertically long division, and if the maximum value of the count is used to quantify the likelihood of occurrence of pseudo contours it is possible to confirm that it substantially matched with what is visually perceived. Accordingly, from the fact that the quantified value and the appearance match, it is possible to change the refresh rate based on this value.

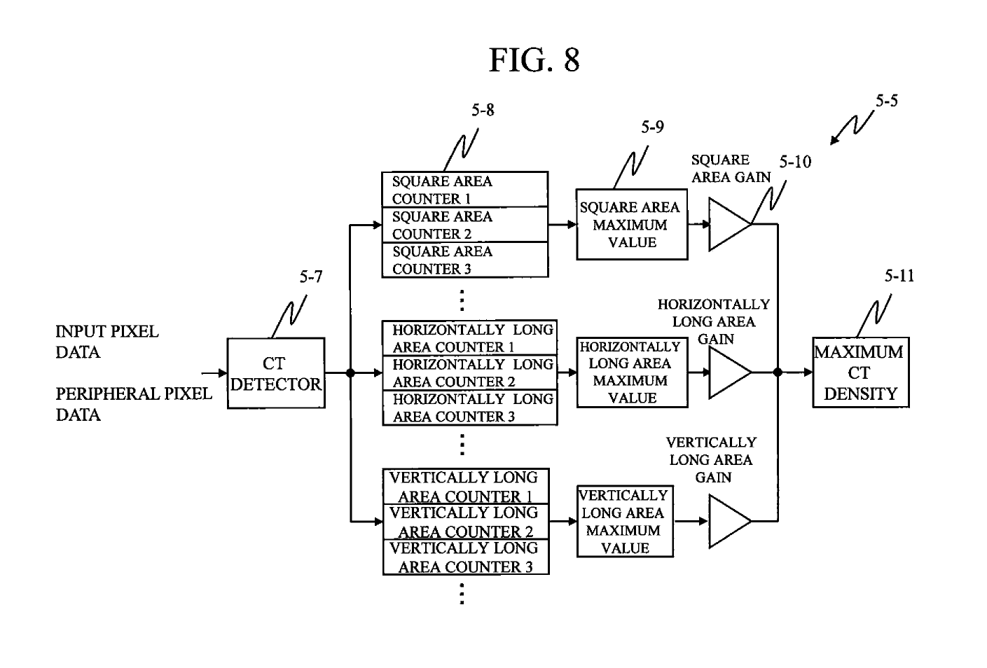

The structure of a data analyzing circuit 5-5 is shown in FIG. 8. It is detected, by a CT detector 5-7, whether or not input pixel data that has been input from outside, and peripheral pixel data that has been generated by delaying the input pixel data using a line memory and latch circuit, contain a critical transition at that pixel. If a critical transition is contained, it is determined what area that pixel belongs to, and it is counted by the counter 5-8 for that area. Each pixel data belongs to either of a divided square area, horizontally long area or vertically long area, and so if input pixel data belongs to the square area 1, for example, the counter for the square area 1 is counted up, while if it belongs to the horizontally long area 1 the counter for the horizontally long area 1 is counted up, and if it belongs to the vertically long area 2 the counter for the vertically long area 2 is counted up. The manner of counting can be set such that in the event that there is a critical transition at all of the four sides, namely upper, lower, left and right, of a subject pixel, the count is four at a time, if at any three sides, three at a time, at any two sides two at a time, or at any one side one at a time, or can be such that there is a count of one if a critical transition exists at any side. Any method is sufficient as long as it is possible to detect whether or not there is a critical transition at a horizontally or vertically adjacent pixel. In that case, it is preferable to count up two at a time if a critical transition exists horizontally and vertically at the same time, or count up one at a time if there is a critical transition either vertically or horizontally.

If CT detection for one screen is carried out, a maximum value is obtained from each counter 5-8, but first maximum values are obtained separately for each division type. Specifically, a square area maximum value, horizontally long area maximum value and a vertically long maximum value are respectively derived, and stored in separate area maximum value registers 5-9 for each division type. The maximum values obtained for every division type are weighted separately for division type, and then compared, and this is realized using separate area gain 5-10 for each division type. The reason for providing gain separately for each division type is that even if, for example, the maximum value of the square area and the maximum value of the horizontally long area are the same, it is not necessarily possible to determine that equivalent pseudo contours will arise. By way of example, if it is determined that the case of the linear CT arrangement is more likely to cause pseudo contours, the horizontally long area gain can made larger compared to the square area gain, and if the likelihood is deemed the same it is possible to make the respective gains the same. Also, because of the tendency for a person's line of sight to move sideways, even for the same linear arrangement of critical transitions, there will be more cases where the vertical arrangement is likely to have an effect than for the horizontal arrangement. Taking this point into consideration, it is possible to assign priority by making the vertically long gain larger than the horizontally long gain. Alternatively, it is also possible to adjust this gain in the case of carrying out area division with different numbers of pixels for the three types of division in FIG. 6. In the previous example, area division was carried out to give the same number of pixels, namely 20×20 for square division and 80×5 for horizontally long division, but if division is carried out with different numbers of pixels by having 40×40 for square division, it is necessary to compensate the count values. In this case, the square area has four times the parameters of the vertically long area, and so comparison is carried out by either dividing the square area maximum value by four or multiplying the horizontally long area maximum value by four. Specifically, since comparison is made using critical transition density (CT density), it is possible to use gain in this density computation.

By providing the separate gains 5-10 for each division type, it is possible to compensate for differences between division types.

Three gain adjusted maximum values calculated separately for division type are further compared to obtain a maximum value, and this value is stored in a maximum CT density register 5-11 as the maximum CT density. The refresh rate control circuit 5-6 selects a refresh rate based on the maximum CT density stored in this maximum CT density register 5-11, and generates respective control signals.

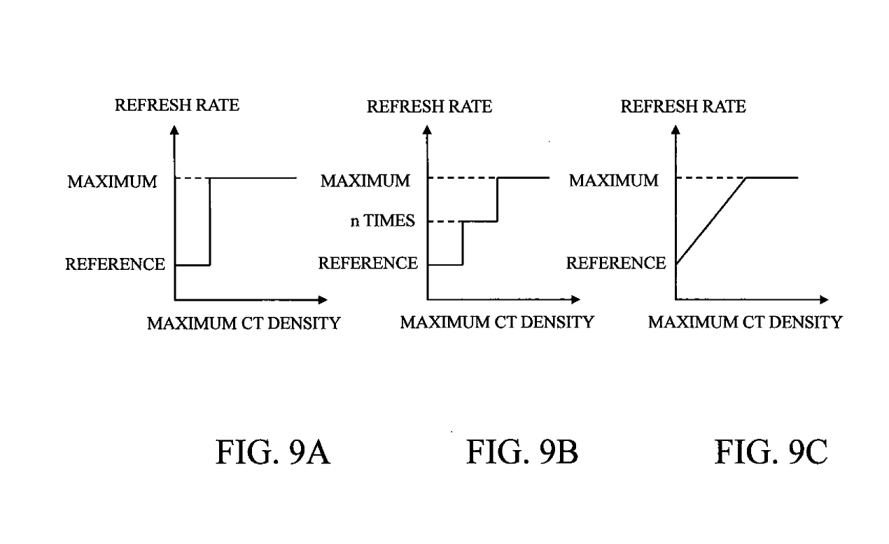

FIG. 9 shows refresh rate setting examples for maximum CT density. For example, as shown in FIG. 9A, it is possible to employ a method where the maximum refresh rate is set if a threshold value, being the maximum CT density, is exceeded, and for a value less than that setting a standard refresh rate (threshold type), or to have method where, as shown in FIG. 9B, refresh rate is raised in steps to twice the speed, three times the speed, n times the speed according to the maximum CT density (step type). It is also possible to have a method where the refresh rate is continuously controlled, as shown in FIG. 9C (continuous type). Specifically, the refresh rate is not a natural number multiple, and can be, for example, 2.8 times or 3.2 times depending on the maximum CT density. In the case of the continuous variation, besides a method of comparing the maximum CT density and increasing the refresh rate, it is also possible to increase the refresh rate in a non-linear way using a quadratic function, a polynomial or an exponential function.

The method of setting the refresh rate according to the maximum CT density, as in FIG. 9, is registered in the data analysis circuit 5-5 or the refresh rate control circuit 5-6 using a look up table or the like constructed of registers etc., and can be arbitrarily set.

It will also be understood that the extent of pseudo contours whose occurrence is anticipated at the critical transitions will be different depending on the bit data. Specifically, with gradation data “31” and “32” related to MSB, it is easy for prominent pseudo contours to arise, but with gradation data “15” and “16” the likelihood is somewhat less. It is also possible to divide and count using this type of difference in extent of pseudo contours. For example, it is preferable to provide six counters N5 to N0, and to perform counting with different counters, such that in the case of pseudo contour caused by data in the vicinity of gradation data “32” counter N5 is counted, in the case of data in the vicinity of gradation data “16” counter N4 is counted, in the vicinity of gradation data “8” counter N3 is counted, in the vicinity of gradation data “4” counter N2 is counted, in the vicinity of gradation data “2 counter N1 is counted, and in the vicinity of gradation data “1” counter N0 is counted. That is, a plurality of counters are prepared for each area, and counting is carried out by changing the counter depending on the extent of pseudo contour. In this way, it is possible to ascertain the extent to which critical transitions of differing extents exist, and to reflect the difference in extent. For example, if critical transitions of only gradation data “32” exist in area 1, while only critical transitions of gradation data “16” exist in area b in the same number as in area a, then the pseudo contours will be more prominent in area a. This difference in extent can be known by confirming count values of each counter.

A quantifying method for the case where critical transitions of differing extent exist involves, for example, weighting number of occurrences of critical transitions (number of CTs) N5 for the area counter N5 with W5, weighting a number of CTs N4 for counter N4 with W4, weighting a number of CTs N3 for counter N3 with W3, and respectively weighting the number of CTs for the other counters with W2, W1 and W0, and by setting such that W5>W4>W3>W2>W1>W0, it is possible to define a real number of CTs P=W5×N5+W4×N4+W3×N3+W2×N2+W1×N1+W0×N0.

If an index P constituting this real number of CTs is used, in area a Pa=W5×N5 while in area b Pb=W4×N4, and if N5=N4 is established then Pa>Pb is obtained, to acquire a numerical value reflecting appearance, and quantification accuracy is improved.

A real CT number is calculated for every area from a value counted from a plurality of counters for each area, and a maximum of these values is obtained, and this value can be stored separately in the maximum value register 509 for each division type. By doing this, after implementing the separate gain 5-10 for each division type for the respective division types, a maximum value is derived from among all the values and stored in a maximum real CT density register 5-11 (maximum CT density register).

The order in which the real number of CTs and the maximum value are obtained can be reversed. Specifically, it is also possible to calculate the real number of CTs after obtaining respective maximum values for separate division types from a plurality of count values for each area. That is, if there is a counter N5 for counting critical transitions of the MSB, the real number of CTs can be calculated using a maximum value of the counter N5 for all areas. In this manner, since it is possible to obtain a real number of CTs using the highest count value with the area, it is possible to detect critical transitions in a wide range.

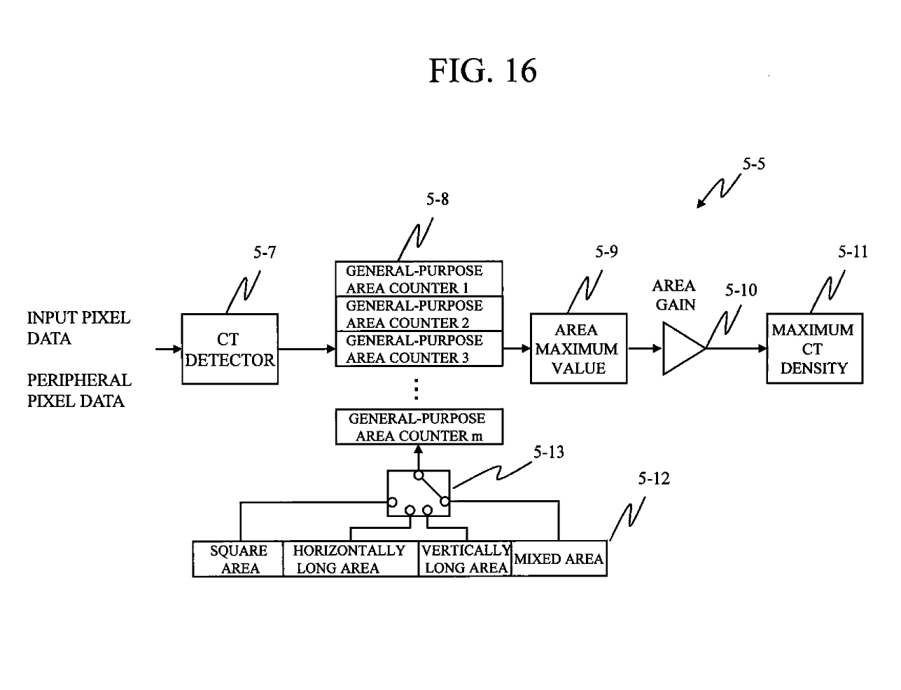

In FIG. 8, an example has been shown of detecting critical transitions simultaneously in three area types, namely a square area, a horizontally long area and a vertically long area, but as shown in FIG. 16, it is also possible to derive maximum values separately for each division type by individually detecting sequentially in time order, over a plurality of frames.

FIG. 16 shows an example of deriving a maximum value for an area of each division type by time division, using general-purpose area counters 508. For example, general purpose area counters 5-8 adopted in a number m are respectively set so as to be assigned to each area using area setting information indicating what counter is assigned to what area, that is stored in an area setting registers 5-12, and to count critical transitions for that area. For example, if there is a square area, 20×20 pixels are made a unit, and in the case of QVGA pixels that are partitioned into areas of 16 columns by 12 rows, an area of row 2 column 3 is set so that the counter 15 counts that area.

Detection of maximum values in areas of each division type for every frame is realized by switching an area selector 5-13. Specifically, when detecting maximum values for a square area, this is realized by switching area information to the square area setting register, using the area selector 5-13. In this way, square areas registered in the square area setting register are assigned to the respective general-purpose area counters 5-8, and critical transitions in those areas are counted. By repeating this for the horizontally long area and the vertically long area, maximum values for areas of each division type are derived, and stored in area maximum value registers 5-9. After area maximum values for each division type have been subjected to the area gain 5-10, they can be stored in the maximum CT density register 5-11, but if the maximum value for the next division type is larger, then a comparison result such that a value is overwritten is reflected in the maximum CT density register 5-11, and after three frames a maximum value for each division type will be stored, and if the maximum CT density register 5-11 is accessed after every three frames it is possible to acquire maximum values separately for division type.

In this way, if detection of maximum values is performed separately for division type using time division, over a plurality of frames, them since it is possible to share the general-purpose area counters 5-8 it is possible to suppress increase in circuit scale. Alternatively, with the same number of counters it is possible to perform detection with finer region division, and so it is possible to improve detection accuracy. However, with time divided detection, a detection period requires a plurality of frames, and detection speed becomes slower, and so it is desirable to adopt this method in cases where there is a lot of still image display. Since detection speed takes priority in cases where there is a lot of moving image display, the simultaneous detection as in FIG. 8 is adopted. It is therefore possible to switch the simultaneous detection of FIG. 8 or the time divided detection of FIG. 16 depending on whether the display content is still pictures or movies.

In FIG. 16, in order to switch detection speed, a mixed area setting register is provided, in addition to the separate area setting registers for each division type (square area, horizontally long area, vertically long area), and switching is carried out using the area selector 5-13. Three types of area information, for a square area, horizontally long area and vertically long area, are registered in the mixed area setting register, and the general-purpose area counters 5-8 are assigned to the mixed area setting register. For example, a third of the m general-purpose area counters are assigned to each of the square area, horizontally long area and vertically long area. Accordingly, compared to separate area division for each division type the number of areas is reduced, and division becomes coarse, but maximum values can be detected at high speed for all separate areas in a single frame period. That is, at the time of movie display, the high-speed nature of the detection is maintained with this mode switching, and conversion of the refresh rate can follow the image.

In determining whether a displayed image is a still picture or a movie, for example, average data for one screen is stored for every frame, if a plurality of frame period variations are continuously seen it can be determined to be a movie, and in this case also, it is possible to divide into a plurality of areas and store average data for every frame, and in the event that there are a lot of areas with continuous change, a movie is determined. In the case of dividing into areas, it is possible to detect movement vectors to determine whether or not the image is a movie. If movie is determined, assignment of general-purpose area counters 5-8 from mixed area setting register information is carried out by the area selector 5-13, and at the same time maximum value detection is carried out for each division type. If still picture is determined, the general purpose area counters 5-8 are assigned by selecting respective setting area registers for the square area, horizontally long area and vertically long area in order for every frame using the area selector 5-13, to perform maximum value detection.

If a movie is detected once, the refresh rate can be fixed. In the case of a movie, display will be smoother the more the image is synchronized with the frame. Accordingly, the refresh rate is fixed to an integral multiple of the input refresh rate.

Also, in the case where there are a lot of still pictures, namely, input of the same data continues, it is possible to detect critical transitions in finer regions if the area to be counted is switched for each division type and further divided for every frame period. For example, with square division, each area of 20×20 (400 pixels) that has been divided into 16 rows and 12 columns is divided again into four areas of 10×10, and if one area of the four finally divided areas is counted in every one frame period, a maximum value is acquired for that divided by four area. In the next frame period, if maximum values of a different divided by four area exceeds the previous value, that maximum value is updated to, and after this has been repeated for four frame periods, maximum values for the areas divided again into 10×10 are obtained, so as to ascertain critical transition distribution more accurately.

In this way, refresh rate changing is carried out for threshold type, step type or continuous type based on maximum CT density or maximum real number of CTs etc. detected over a single frame period or a plurality of frame periods, and it is possible to efficiently suppress pseudo contours.

The fact that it is possible to improve pseudo contours by changing refresh rate can be described by defining display instability E, as follows. Using latent brightness fluctuation ΔL, original brightness L, light emission duty ratio γ, frame period T, and line of sight movement time τ in which line of sight moves by only a unit pixel, display instability E can be defined as E=(ΔL/L)·γ·(T/τ). The latent brightness fluctuation ΔL is represented by the magnitude |L*−L| of a difference between an assumed brightness L* assumed in the case where line of sight movement has occurred, and the original brightness L, and can be predicted by looking at a subframe pattern, that is, the bit arrangement of image data For example, if line of sight movement occurs as in FIG. 3 and FIG. 4, L* is proportional to “63(111111)” due to a bit OR of gradation data “31(011111)” and “32(100000)”, and the latent brightness fluctuation ΔL becomes assumed brightness value “63”=original brightness value “31”, which is a value proportional to gradation data “32”.

As shown in FIG. 3 and FIG. 4, if there is no line of sight movement pseudo contours do not arise, but this is equivalent to there being no line of sight movement, that is, a display instability E of 0 when the line of sight movement period τ=∞, and also the fact that pseudo contours arise if line of sight movement occurs is the same as display instability E increasing because the line of sight movement period τ is reduced. First, in the case of gradation control in subframes, an attribute causing latent brightness fluctuation ΔL is provided in the gradation data. If the bit arrangement for adjacent gradation data is looked at, this will be understood, and the fact that the extent of this is dependent on the input data was described previously.

For example, latent brightness fluctuation ΔL in a case related to the MSB, such as gradation data “31(011111)” and “32(100000)” becomes a maximum of “32” as described before, and since actual appearance is evaluated with respect to the original brightness the extent of pseudo contours potentially becomes brightness fluctuation rate ΔL/L, and is almost 1. With a case where gradation data “15(001111)” and gradation data “16(010000) are adjacent, latent brightness fluctuation ΔL is “16”, but brightness fluctuation rate ΔL/L is almost 1 in this case also, becoming the same. The actual extent to which pseudo contours appear in display is the extent to which this latent brightness fluctuation rate occurs for line of sight movement, namely how long brightness fluctuation continues for with respect to speed of line of sight movement.

Since with high gradation the light emission duty cycle γ becomes longer, display instability is increased, and instability is improved with lower gradation. Also, since instability increases as line of sight movement becomes faster, that is, as the line of sight movement time τ becomes shorter, instability can be reduced by making the frame period T short compared to the line of sight movement time τ. Specifically, it is possible to explain that it is possible to bring about display stability by making the refresh rate fast with respect to the line of sight movement speed.

In order to stabilize the display with sub-frame type digital driving as much as possible, it is necessary to reduce display instability E with the fastest line of sight movement speed. Accordingly, with maximum line of sight movement speed, that is minimum line of sight movement time τₘᵢₙ, if, for example, it is considered that the inequality display instability E<e (where e is a constant) is always held, then it is necessary to satisfy ΔL/L·γ<e·τₘᵢₙ/T. The left side varies according to the content of the image data, and so is not constant. An image that includes latent brightness fluctuation, that is an image that includes critical transitions, is made the subject, and desirably has its maximum value. Since the right side should be larger than the left side, if the frame period T is set to a maximum value that satisfies the above equation, it is possible to achieve the most efficient stabilization of display.

In actual fact, since the case where pseudo contours exist to a certain extent bunched together has been recognized, it is possible to use a critical transition density indicating the extent to which critical transitions exist within a unit region, or a quantitative value corresponding to how they are distributed, on the left side. Alternatively, it is possible to calculate the left side (ΔL/L·γ) from image data, add each area to calculate a sum, and give a quantification index. As described previously, if a maximum value of values in divided areas is derived, a value that is added with the extent of critical transitions is obtained.

In this way, it can be said that the method of changing refresh rate according to image content is an effective way of efficiently ensuring display stability at a particular level or better.

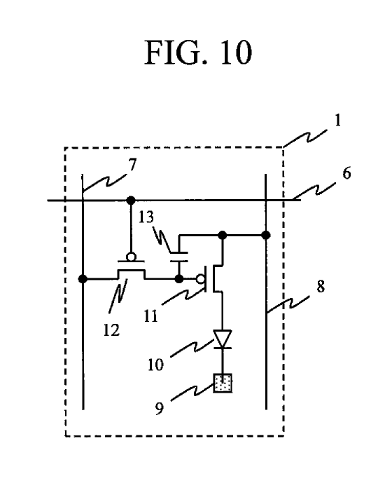

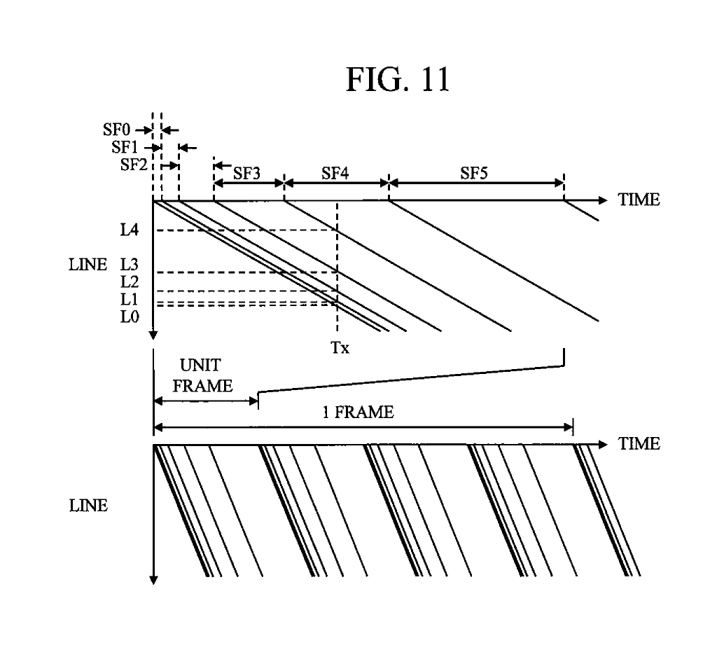

FIG. 10 shows the structure of a pixel, while FIG. 11 shows a digital drive timing chart for an example of high speed refresh rate, for example, four times speed. As shown in FIG. 10, the pixel 1 is made up of an organic EL element 10, a drive transistor 11, a select transistor 12, and a storage capacitor 13. An anode of the organic EL element 10 is connected to a drain terminal of the drive transistor 11, while the cathode of the organic EL element 10 is connected to a cathode electrode 9 common to all pixels. A source terminal of the drive transistor 11 is connected to a power supply line 8 common to all pixels, while the gate terminal is connected to one terminal of the storage capacitor 13 having its other terminal connected to the power supply line 8, and to a source terminal of the select transistor 12, and the gate terminal of the select transistor 12 is connected to the select line 6, with the drain line being connected to a data line 7. However, the power supply line 8, and cathode terminal 9 are not shown in the overall structural diagram.

If the select line 6 is selected (made Low) by the select driver 4, the select transistor 12 conducts, and a data potential supplied to the data line 7 is fed to the gate terminal of the drive transistor 11, to perform on/off control of the drive transistor 11. For example, when the data potential on the data line 7 is Low, the drive transistor 11 is conductive, and current flows into the organic EL element 10 to emit light, while when the data potential is High the drive transistor 11 is off, current does not flow in the organic EL element 10, and it is turned off. Because the data potential brought to the gate terminal of the drive transistor 11 is stored in the storage capacitor 13, even if the select transistor 12 is not select driven by the select driver 4 (even if the data potential is made High), the on or off operation of the drive transistor 11 is maintained, and the organic EL element 10 continues in a lit state or unlit state until accessed in the next subframe. In FIG. 10, the pixel 1 is made up of only P type transistors, but it is also possible to use N type transistors in part, or to use all N type transistors. Also, structures other than that of FIG. 10 can be adopted as the pixel.

The upper part of FIG. 11 shows a subframe structure for a unit frame period capable of 6-bit gradation display using 6 subframes. Specifically, 6-bit gradation display is possible even with unit subframes only. A subframe commences from a lower order bit SF0, and displays six bits once the upper order bit SF5 is concluded. However, it is not necessary for a subframe to be executed from the lower order bit to the higher order bit, and it is possible to have an order of from the higher order bit to the lower order bit, or even in a random order. In carrying out the driving such as shown in the upper part of FIG. 11 using the display device of FIG. 1, in a period Tx a plurality of lines L0 to L4 must be selected in a time multiplexed manner, and control must be carried out so as to write bit data to a line corresponding to that bit data. Specifically, in period Tx it is necessary to perform time divided selection so that bit 0 is written to line L0, bit 1 is written to line L1, bit 2 is written to line L2, bit 3 is written to line L3, and bit 4 is written to line L4. One example of this type of control method is shown in detail in U.S. Patent Application Publication No. 2008/0088561 A1, and so description will be omitted here.

If a unit frame period shown in the upper part of FIG. 11 is, for example, ¼ of a frame period, there will be four unit frames in a single frame, as shown in the lower part of FIG. 11, and display at four times speed is carried out. Specifically, it is possible to vary the refresh rate by changing this unit frame period.

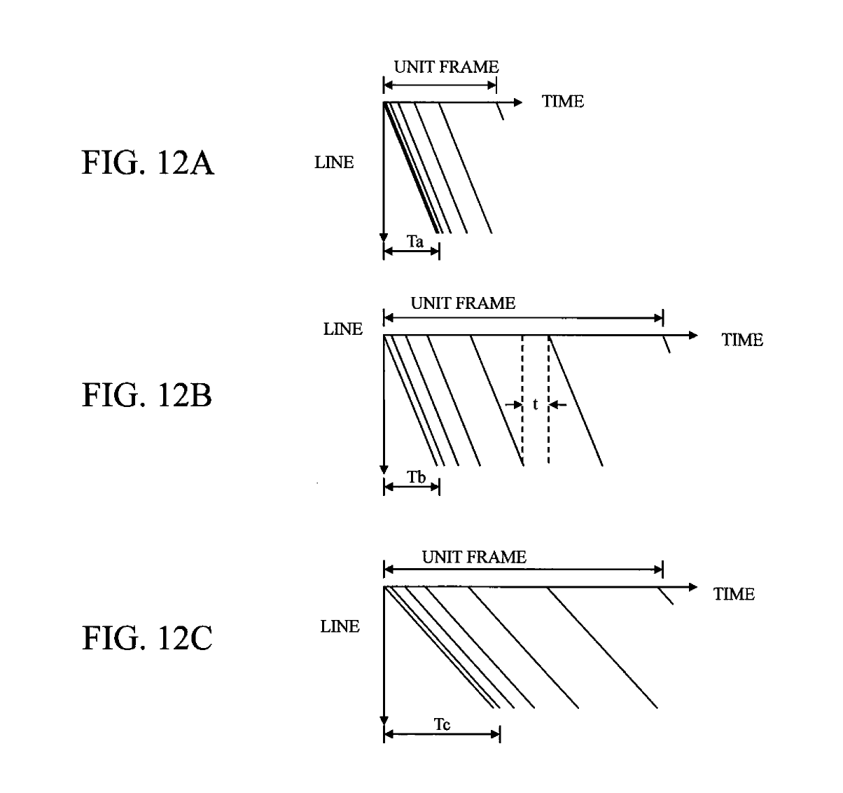

Examples of changing the unit frame period are shown in FIG. 12A to FIG. 12C. If four times speed is made the maximum refresh rate, then the minimum unit frame becomes as shown in FIG. 12A. In the case of lowering the refresh rate, that is, in the case of increasing the unit frame period, it is possible to fix the horizontal period, as in FIG. 12B, maintain the ratios of each of SF0-SF5 at 1:2:4:8:16:32, and widen the interval between each subframe (subframe period expansion method). In this way, since the refresh rate is reduced, power consumption is lowered. Using the subframe expansion method of FIG. 12B, if the subframe interval becomes wide, periods such as period t where no lines are selected appear frequently. By stopping control signals such as clocks in this period, it is possible to further reduce power supply, which is more efficient.

Alternatively, it is also possible, as in FIG. 12C, to expand the horizontal period to widen the unit frame interval (horizontal period expansion method). With the method of expanding the horizontal period, since the horizontal period becomes longer, the time for all lines to complete each subframe becomes longer, but similarly the refresh rate is lowered, and so power consumption is reduced.

By varying the unit frame period in this way, the refresh rate can be easily changed, but it is necessary to consider periods in which the refresh rate shifts in accordance with content of the image. In the case of subframe period expansion, since the horizontal period is fixed, the time Tb (=Ta) for completion of writing for all lines is the same regardless of the refresh rate, and there is little disturbance of the image with movement. However, with the horizontal period expansion method, the writing period Tc (≠Ta) for all lines is dependent on the refresh rate and will differ. Specifically, with a movement period before and after changing of the refresh rate, a light emitting period will differ between a particular line and another line, making image disturbance likely. It is therefore possible for refresh rate switching to be carried out instantaneously, but it is preferable to carry out processing to change the refresh rate gradually and as smoothly as possible.

For example, when the data analysis circuit 5-5 determines so as to switch from two times speed to four times speed, the refresh rate control circuit 5-6 does not switch from two times speed to four times speed instantly in the next frame, but preferably performs control so that in the ensuing frames the refresh rate is changed to a rate between two times and four times speed, for example three times speed, to eventually be changed to four times speed. Since the refresh rate change curbs degradation of an image with a conversion process, it is desirable to synchronize to an input frame or a unit frame.

This kind of change in driving timing is appropriately carried out by changing data read control signals from the frame memory 5-2, control signals for switching the multiplexor 3, a clock of the select driver 4 etc., and these signals are generated by the refresh rate control circuit 5-6.

Also, in order to efficiently suppress pseudo contours are, it is possible to divide, for example, a subframe SF5 having a long light emitting period into a number of subframes. For example, SF5 is divided into two identical periods, and if these are called SF5-1 and SF5-2 data “32” from SF5 is divided into two using data “16”. If this is done, data “32” can be expressed as data “16” from SF0-SF4 and data “16” from SF5-1, and so it is possible to alleviate the effects caused by the critical transition. The division of SF5 can be into three or into four periods, and the proportion at which to divide can also be variously set.

In a situation where the screen size become large and resolution is increased, it is possible to change the refresh rate by using sub-pixels, as described in the following.

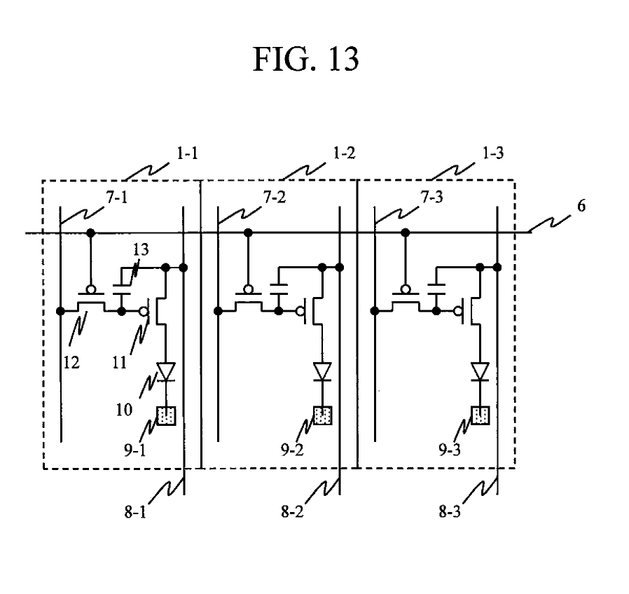

The pixel of FIG. 13 is an example of a single pixel having three of the pixels 1 of FIG. 10 arranged as sub-pixels, with a select line 6 made common. A sub-pixel 1-1 generates a light intensity corresponding to data of higher order bits, sub-pixel 1-2 generates a light intensity corresponding to data of middle bits, and sub-pixel 1-3 generates a light intensity corresponding to data of lower order bits. To obtain different emitted light intensities between sub-pixels, it is possible to make the light emitting surface area of the organic EL elements 9-1, 9-2 and 9-3 of each of the sub-pixels different, but it is preferable, as shown in FIG. 13, to have an adaptable structure by providing a different power supply line to each sub-pixel, and supplying different power supply potentials, such as VDD1 to the power supply line 8-1 of sub-pixel 1-1, VDD2 to the power supply line 8-2 of sub-pixel 1-2, and VDD3 to the power supply line 8-3 of sub-pixel 1-3. For example, to realize a 12-bit gradation with three sub-pixels, it is possible for each sub-pixel to generate a 12÷3=4-bit gradation. However, because the sub pixel 1-1 corresponding to the upper order bits corresponds to bits 11-8, which are the upper four bits of the 12 bits, the sub pixel 1-2 corresponding to the middle bits corresponds to bits 7-4, which are the next four bits, and the sub pixel 1-3 corresponding to the lower order bits corresponds to bits 3-0, which are the remaining lower four bits, it is necessary to set light intensity ratios for the same light emitting period to 256:16:1. Deriving the maximum 256:1 light intensity ratio using a light emitting surface area ratio is difficult to achieve accurately, and adjustment is not possible after manufacture. It is possible to more easily and accurately adjust light emission intensity ratios with a structure that can set a power supply potential separately for each sub-pixel, as shown in FIG. 13.

By selecting the select line 6 that is common to all sub-pixels, and respectively supplying bit data of one from each of the upper 4-bits, the middle 4-bits and the lower 4-bits to the respective data lines 7-1, 7-2 and 7-3 of each subpixel, bit data is simultaneously written to three sub-pixels. For example, among the lower 4 bits, if the subframe SF2 for bit 2 is commenced, respective data of the upper bit 2 (bit 10), the middle bit 2 (bit 6) and the lower bit 2 (bit 2) are supplied to the data lines 7-1, 7-2 and 7-3, and written to the sub-pixels.

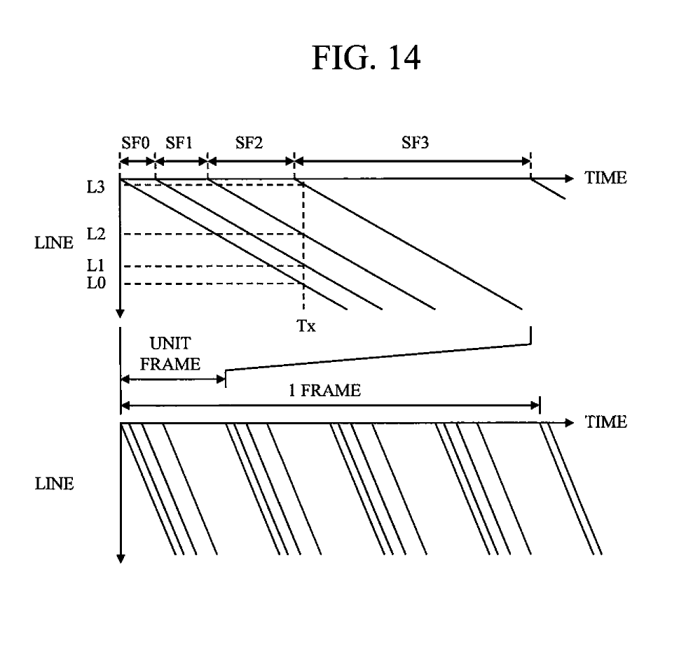

An example of a subframe structure for carrying out 12-bit gradation display at four times speed using the pixel of FIG. 13 is shown in FIG. 14. As described previously, the sub-pixel is constructed from SF0-SF3, having 4-bit gradation, namely having subframe periods in a ratio of 1:2:4:8. A unit frame capable of 4-bit gradation display is shown in the upper part of FIG. 14, and by repeating the unit frame four times in a single frame period, as shown in the lower part of FIG. 14, pseudo contours are suppressed. In order to more efficiently reduce pseudo contours, it is possible to further divide the subframe SF3 of the MSB.

Here also, similarly to FIG. 11, in period Tx lines L0-L3 are selected in a time divided manner, but control is performed so that bit 0 is written to line L0, bit 1 is written to line L1, bit 2 is written to line L2, and bit 3 is written to line L3.

By adding a sub-pixel sharing the select line, as shown in FIG. 14, it is possible to transfer more bit data, and so it is possible to reduce the number of subframes and give multi-gradation display. In this case, it is possible to generate 12-bit gradation with 16 subframes, even if driving is carried out at four times speed. If this were realized with single pixels, it would require 12×4=48 subframes, and it would become three times the speed of FIG. 14.

It is necessary to increase the number of lines to make display higher resolution, and it is necessary to reduce the selection period for one line. Also, since wiring loss is increased if a large screen is made, it is not possible to shorten the select time of a single line. Therefore, if high resolution and large screen size are implemented, increase in subframes becomes difficult, and it is extremely difficult to include 48 subframes to generate four times speed 12-bit gradation. However, if three sub-pixels are introduced, it is possible to realize four times speed 12-bit gradation in 16 subframes, and so sufficient driving becomes possible even with higher resolution and a large screen.

In the case where it is not possible to provide three sub-pixels, it is preferable to provide two sub-pixels. If sub-frame 1-1 is made the upper 4 bits and subframe 1-2 is made the lower 4 bits, and bit data is divided in two, namely into upper order bits and lower order bits, it is possible to achieve 8-bit gradation in 16 sub-frames (four subframes in a unit frame). If it is possible to introduce four sub-pixels, since they are divided into upper bits, middle upper bits, middle lower bits and lower bits, it is possible to achieve 12-bit gradation with 12 subframes (three subframes in a unit frame).

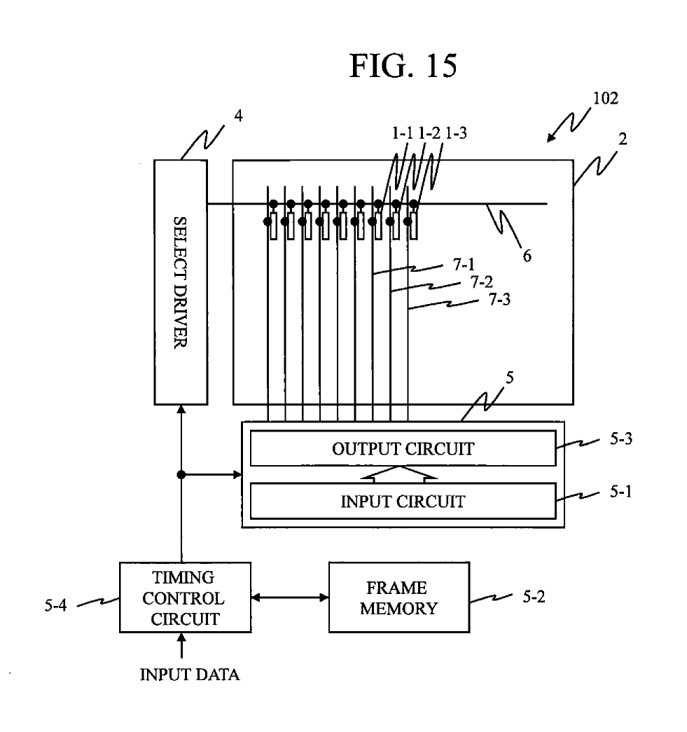

Overall structure of a display device containing the pixels of FIG. 13 is shown in FIG. 15. Structural elements having the same reference numerals perform the same operations as in FIG. 1, and so description is omitted. With the display device 101, three sub-pixels 1-1 to 1-3 are provided for a unit pixel, there are data lines 7-1 to 7-3 corresponding to these pixels, and the number of data lines becomes three times that of the display device 101. It is therefore necessary for the number of outputs of the data driver 5 to also correspond to this increased number of data lines.

Since it is assumed that the display device 102 is a large type, the multiplexor 3 that was provided in the display device 101 is omitted. This is because if the multiplexor 3 were to be provided, high speed drive would not be possible due to the on resistance of the multiplexor 3. Specifically, the data lines 7-1 to 7-3 are directly connected to outputs of the data driver 5. The data driver 5 therefore secures a number of outputs for data lines sufficient for data lines 7-1 to 1-3 for each of RGB. For example, in the case of full Hi-Vision, the horizontal resolution is 1920, and so the number of outputs of the data driver 5 is 1920×3(RGB)×3=17,280. Supplying only this number of outputs with a single driver IC is not common practice, but with a plurality of ICs this number of outputs is possible. For example, with a 720 output driver IC, 24 driver ICs would suffice.

The data driver 5 is constructed of only a simple digital circuit including an output circuit 5-3 provided with the same number of outputs as there are data lines of the display array 2, and an input circuit 5-1 for converting dot unit data input to the data driver into line units, which results in the number of outputs being three times, and it is easy to achieve reduced cost. Also, since the frame memory is provided outside the data driver 5, it is possible to use low cost general-purpose components. It is also possible to use a built-in memory type data drive such as shown in FIG. 1 as the data driver, if it is possible to provide a frame memory at low cost.

Dot unit data input from outside is first input to the timing control circuit 5-4, a built in data analysis circuit 5-5 calculates maximum CT density or maximum real CT density within the input image, and a refresh rate appropriate to the calculated value is set in the refresh rate control circuit 5-6. Refresh rate control at this time is carried out in synchronization with an input frame or a unit frame, and in this transition period also control is carried out so as to change the refresh rate smoothly. The refresh rate control circuit 5-6 generates each timing signal at the set refresh rate, and supplies the timing signals to the data driver 5, frame memory 5-2 and select driver 4.

Input data is stored in the temporary frame memory 5-2, by way of the timing control circuit 5-4, and if the subframe as shown in FIG. 14 commences bit data corresponding to that subframe is read out and input by way of the timing control circuit 5-4 to the data driver 5. For example, in the case where the data is 12 bits, if SFT commences bit 10, bit 6 and bit 2 data written to each sub-pixel of a corresponding line is read from the frame memory 5-2, and transferred to the input circuit 5-1. The input circuit 5-1 stores data for each sub pixel that is input in dot units, in single line portions, converts to line data, and transfers the line data to the output circuit 5-3. The output circuit 5-3 supplies line data from the input circuit 5-1 to data lines 7-1 to 7-3 of each sub-pixel in line units, and bit data corresponding to the subframe is written to pixels of a line selected by the select driver 4. Specifically, here data of bit 10, bit 6 and bit 2 of SF2 are written to respective subpixels 1-1, 1-2 and 1-3. This operation is repeated for each line and each subframe, as shown in FIG. 14, and double speed driving is carried out at a timing generated by the refresh rate control circuit 5-6, to suppressing pseudo contours while maintaining multiple gradations. Also, in the event that maximum CT density or maximum real CT density is low, it is possible to proactively lower the refresh rate, which makes it possible to lower power consumption for drive systems, even if the display size is large.

The content of this embodiment as described above is not limited to an organic EL display, and it goes without saying that it can also be applied to situations of subframe type digital driving in a self emissive display such as a plasma display or field emission display having comparatively fast response, or an inorganic EL display, or in an optical device such as a DMD (Digital Micro Mirror Device).

With the above-described embodiment, in cases where pseudo contours are likely to occur, a number of unit frames is increased, but other actions are possible. For example, it is possible to edit image data, change image data for sections where pseudo contours are likely to occur (for example, +1 or −1), increase or reduce brightness of the overall image data slightly, etc. It is also possible to change only a number of divisions of an MSB subframe, and in addition to these processes it is also possible to increase the number of unit frames and improve the effect of reducing pseudo contours.

The invention has been described in detail with particular reference to certain preferred embodiments thereof, but it will be understood that variations and modifications can be effected within the spirit and scope of the invention.

### PARTS LIST

1 pixels
1-1 subpixel
1-2 subpixel
1-3 sub-pixel
2 pixel array
3 multiplexor
4 select driver
5 data driver
5-1 input circuit
5-2 frame memory
5-3 output circuit
5-4 timing control circuit
5-5 analyzing circuit
5-6 rate control circuit
5-7 CT detector
5-8 counter
5-9 value registers
5-10 separate area gain
5-11 CT density register
5-12 setting registers
5-13 area selector
6 select lines
7 data lines
7-1 data line
7-2 data line
7-3 data line
8 power supply line
8-1 power supply line
8-2 power supply line
8-3 power supply line

### PARTS LIST CONT'D

9 cathode electrode
9-1 organic EL element
9-2 organic EL element
9-3 organic El element
10 organic EL element
11 drive transistor
12 select transistor
13 storage capacitor
101 display device
SF5 subframe
SF2 subframe

1. A method for driving an electroluminescent display, comprising:
(a) providing the electroluminescent (EL) display having a pixel array having a plurality of pixels arranged in a matrix, a plurality of select lines arranged for each line of pixels and a plurality of data lines arranged for each column of pixels, a select driver for selectively driving the select lines, and a data driver for driving the data lines, wherein each pixel includes an organic EL element and a drive transistor for causing current to flow into the organic EL element to cause it to emit light;
(b) receiving an image having input data for each pixel;
(c) dividing the input data for each pixel into a plurality of bit data values for a plurality of sub-frames, respectively;
(d) dividing the input data into a plurality of areas, analyzing the input data for each area to detect critical transition (CT) pixels for which pseudo contours occur with line of sight movement, and calculating a CT density for display of a single screen based on analysis results of each area;
(e) selecting a refresh rate based on the calculated CT density; and
(f) providing the bit data of the plurality of sub-frames sequentially to the respective pixels during one or more unit frame period(s) to cause the pixel array to display images at the selected refresh rate, wherein the unit frame period(s) corresponds to the refresh rate.

2. The display device of claim 1, wherein step (d) further includes:
(i) dividing the input data into blocks using a plurality of different methods;
(ii) determining respective likelihoods of occurrence of pseudo contours for each block using the plurality of methods; and
(iii) determining a likelihood of occurrence of pseudo contours in display of one screen based on the analyses of each block divided with the respective methods.

3. The method of claim 2, wherein the plurality of methods include dividing into square regions made up of a plurality of pixels of the same height and width, and a dividing into rectangular regions having different height and width.

4. The method of claim 3, wherein the rectangular regions of the plurality of methods include horizontally long rectangular regions and vertically long rectangular regions.

5. The method of claim 2, wherein step (d)(iii) further includes assessing a weight for each method.

6. The method of claim 1, wherein step (d) further includes determining the number of areas in the plurality of areas according to a frequency of image variation.

7. The method of claim 6, wherein when the frequency of image variation is low, the number of areas is increased, and when the frequency of image variation is high, the number of areas is decreased.
